(19) United States
(12) Patent Application Publication
(10) Pub. No.: US 2014/0017472 A1
(43) Pub. Date: Jan. 16, 2014

(54) HEATED GLAZING

(71) Applicants: Dominique Coster, Jumet (BE); Jean-Michel Depauw, Jumet (BE)

(72) Inventors: Dominique Coster, Jumet (BE); Jean-Michel Depauw, Jumet (BE)

(73) Assignee: AGC GLASS EUROPE, Bruxelles (Watermael-Boitsfort) (BE)

(21) Appl. No.: 14/009,553

(22) PCT Filed: Apr. 12, 2012
(86) PCT No.: PCT/EP2012/056599

§ 371 Date: Oct. 3, 2013

(30) Foreign Application Priority Data
Apr. 12, 2011 (BE) BE 2011/0218

(51) Int. Cl. B60J 1/00

(52) U.S. Cl. CPC B60J 1/002
USPC 428/219; 428/220

(57) ABSTRACT

The present invention relates to a laminated glazing for a motor vehicle, the light transmission of which is no less than 70%, including two sheets of glass assembled together by means of an intermediate thermoplastic sheet; the glazing further comprises a system of electrically conductive thin functional layers applied to a surface of one of the glass sheets, and arranged between said sheet and the intermediate sheet, the system of conductive layers being supplied by means of conductive strips arranged on said layers and on either side of the glazing, wherein the total thickness of the sheets of glass of the glazing is equal to a maximum of 3.8 mm.

The present invention relates to heating “automobile” glazings. In a more precise manner the invention relates to glazings comprising a heating assembly consisting of conducting thin layers and dielectric layers applied to the glass substrate.

Heating “automobile” glazings comprising an assembly of conducting thin layers, are well known. Glazings of this type are in particular proposed for implementation in windscreens. In these applications the conducting layers are mainly used as an infrared filter to preclude warming of vehicles exposed to solar radiation. The systems of layers used must satisfy the optical demands specific to these uses. For windscreens, a luminous transmission of at least 70% is demanded. The presence of these systems of layers must not lead to undesirable colorations, in particular in reflection, whatever the angle at which the glazing is observed.

To meet the requirement of manufacturers, traditional windscreens, in order to achieve demisting or deicing in acceptable time conditions, must develop an estimated power of about 400 w/m², and more if possible. A recognized difficulty is to achieve such a power with conducting layers that are producible and that make it possible to satisfy the conditions recalled hereinabove. The systems of layers in question traditionally comprise one or more thin metallic layers which develop their power through the Joule effect. The resistance of the layers depends on their thickness. The voltage applicable in vehicles is regulated. It does not normally exceed 14 v. Under these conditions it goes without saying that the power is limited by the strength of current that can pass through these layers. The strength of current is itself dependent on the resistance. Consequently the trend is for increasing thickness of conducting metallic layers, but this thickness remains limited by the need to maintain a regulatory luminous transmission.

To meet these diverse constraints, efforts have dealt mainly with the optimization of the systems of layers so as to achieve as low a resistance as possible. The quality of the conducting layer or layers is necessarily considered. The optimization of the assembly of layers of the system, including the dielectric layers which limit reflections, and improve transmission, make it possible to slightly alter the thickness of the conducting metallic layer while preserving the required luminous transmission. Nonetheless, the improvements are also restricted.

Even when optimized, the systems of layers, as has just been indicated, do not customarily make it possible to achieve the required powers for lack of employing sufficiently poorly resistive layers. Under the best conditions reported the resistances are of the order of 1.2ω/□. But having regard to the dimensions of modern windscreens (of the order of 70 to 100 cm or more), the power obtained under the best conditions does not customarily exceed values of the order of 350 w/m².

Powers of this order are not in principle sufficient to deice windscreens rapidly. For this reason, in spite of the interest manifested by manufacturers, these functions have not found any outlet in industrial applications.

Efforts undertaken moreover to lead to the lightening of vehicles so as to reduce their consumption, are aimed equally at all elements liable to succeed without however impairing the functionalities of these elements. With this aim it has been proposed to limit the weight of glazings. This limitation relates to all glazings installed on vehicles and, in particular, windscreens which customarily constitute the largest of them.

In commonest practice, windscreens consist of two glass sheets, each of the order of 2 mm in thickness, assembled by means of a traditionally thermoplastic insert sheet of 0.76 mm. The elements determining the choice of the thicknesses are multiple. Mechanical strength forms part of these elements. Properties aimed at sound-proofing are also an appreciable factor in so far as the mass intervenes to a significant extent in the damping of acoustic vibrations.

In spite of the reservations mentioned hereinabove, the inventors have tried to find structures of glazings exhibiting a set of properties satisfying all these conditions. The inventors have thus produced laminated windscreens whose thicknesses of glass do not exceed 3.8 mm and preferably are less than 3.5 mm and may be even less than 3.2 mm.

Such windscreen are advantageously obtained by combining glass sheets of different thicknesses. The thickest sheets are normally directed towards the outside. This arrangement improves, in particular, mechanical resistance to “gravel test”.

In practice the implementation of the sheets requires that the thinnest sheets remain convenient to handle, whether manually or by mechanical means of robot type. The thinnest sheets must also lend themselves without excessive difficulties to treatments leading to the products according to the invention. Such is the case in particular for treatments which cause a rise in their temperature. This entails for example the formation of systems of functional layers. The depositions carried out, even if the temperatures remain relatively low, may lead to deformations leading to uniformity defects of the layers. The operations of shaping the sheets and their subsequent assemblage also require a minimum of initial rigidity, in particular for the conveying and proper positioning of the sheets.

In practice the thickness of the thinnest sheets employed is not less than 0.8 mm, and preferably not less than 1.0 mm. In an advantageous manner, the glazings according to the invention comprise at least one glass sheet whose thickness is not greater than 1.6 mm and advantageously is not greater than 1.4 mm.

To achieve lightweight glazings whose total thicknesses correspond to the values indicated above, the sheets associated with the thinnest sheets have a thickness which is not greater than 2.5 mm, and is preferably less than 2.1 mm, and may be equal to or less than 1.9 mm.

Assembly is carried out by means of a thermoplastic sheet of material traditionally used for these laminated assemblies. This mainly entails sheets of polyvinyl butyral (PVB), but also of ethylene vinyl acetate (EVA) or of polyurethane (PU). This material is of much lower density than glass. A modification of the thickness of the insert sheet with a view to lightening the glazing does not offer any appreciable improvement in as much as this thickness must offer sufficient resistance against the ejection of passengers. The traditional thicknesses of PVB sheets used in automobile glazings are at least 0.38 mm and usually 0.76 mm for simple insert sheets. Distinct products are sometimes proposed in order to build in extra functions. Such is the case for example with the interlayers used for so-called “head-up” or HUD (head up display) windscreens in which the interlayers customarily exhibit a thickness which varies over the height of the windscreen.

The production of thin laminated glazings also presents a few singularities as regards the techniques used for their forming. The lightening of the sheets does not facilitate their handling because, in particular, of diminished rigidity. Likewise the use of sheets of different thicknesses leads to the need to adapt the techniques which are contingent on the thermal properties of the sheets. The latter do not absorb in an identical manner the energy employed to bring them to the state of softening suitable for their shaping.

All these reasons are as many reservations as regards the use of these less thick windscreen.

Brushing aside these constraints, the inventors have shown the interest afforded as regards the application of systems of heating layers on windscreens of reduced thickness. Though the formation of these systems of layers on thin glass sheets requires increased precautions in order to avoid the formation of specific defects of these sheets, it is apparent that the glazings thus constructed offered improved possibilities as regards heating.

Moreover the inventors have progressed further in the properties of systems of heating layers, attaining still more reduced resistances. Thus the inventors have achieved systems of layers whose resistance may be less than 1Ω/□ and may even be equal to or less than 0.8Ω/□. The glazings exhibiting these properties moreover preserve a satisfactory luminous transmission, are coloured very little if at all in reflection whatever the angle of observation, and withstand thermal shaping treatments without impairment.

The heating system of layers is in contact with the interlayer, that is to say in position 2 or 3 according to the customary designation, position 1 corresponding to the face of the glazing directed towards the outside of the vehicle. These two positions imply that the system of layers is protected against impairments, in particular mechanical impairments. But the inventors have shown the benefit preferably of arranging this system of layers in position 2. They have indeed shown that the elimination of ice which constitutes the most demanding function in terms of necessary power, is then faster.

The reason for this effect is probably related to the fact that the thermoplastic sheet is less conducting than the glass. The interposition of this sheet between the face covered with ice and the heating layer reduces the extent of the power which reaches the surface of the glass.

Conversely, the presence of the heating system of layers in position 3 favours the warming of that face of the glazing that is directed towards the cabin. In this position the function for eliminating mist, or even ice formed by extremely low temperatures, is substantially improved. It is all the more so as the glass sheet directed towards the inside is advantageously the least thick, and as consequently the thermal conduction is increased in the direction of the cabin.

Though it may be preferred for the reason indicated hereinabove, the arrangement of the system of layers in position 2 leads to the superposition on the same face of the glass sheet of this system of layers and of the enamelled edges used to conceal the gluing of the glazings. This superposition of an enamel and of the system of layers requires very controlled conditions for the preparation of these glazings so as to avoid the defects which may result from the contact of these two sorts of materials. The conducting elements (“busbar”) powering the system of layers must furthermore be added to the superposition.

When the laminated glazing does not comprise any functional layers which reflect infrared, the masking enamels are ordinarily “baked” in the course of the step of shaping the windscreen to carry out a single thermal treatment operation. In the presence of a system of reflecting layers, the baking operation operated at the same time as the shaping can be carried out only if the functional layers are not on the face bearing the enamel. Stated otherwise, the enamel being in position 2, the system of layers must be situated in position 3. If the system of layers is arranged in position 2, the enamel must be baked before the deposition of the system of functional layers. But even in this case it is necessary to ensure that the heating system of layers exhibits good electrical continuity between the part applied to the enamelled strips and that which extends over the part of the glazing which is not coated with enamel.

In the heating glazings according to the invention the electrical power supply is ensured by “busbar” conductors of lowest possible resistance so as not to lead to the development of a perceptible Joule effect and therefore to a lowering of the available voltage for the systems of conducting layers.

To minimize the resistance of the system of layers of the glazing the busbars are arranged on two opposite edges of the glazing corresponding to the smallest distance. In the configurations of the most usual windscreens this smallest distance corresponds to their height. This height tending to grow, the arrangement of the busbars on the sides of the windscreens may become equal or even lower. In this case the busbars will be arranged on the sides.

The busbars used according to the invention are of traditional materials for this use. These entail very slender metallic bands, in particular copper bands. Still more frequently these entail strips of conducting enamel, in particular based on silver.

Whatever the nature or the position of the busbars on the windscreen, these conductors are masked towards the outside of the vehicle by the enamelled strips which also hide the gluing trails. It is also traditional to contrive matters so that the systems of layers do not extend up to the edge of the glazings so as to avoid impairment in contact with atmospheric moisture.

In order that the limit of these functional layers not be perceptible it is preferably situated behind these masking enamels, which, at least here and there, can be produced in the manner of a gradation of dots from a zone completely coated with the enamel at the edge of the glazing, up to the part entirely devoid of this enamel.

The choice of the systems of functional layers is decisive for attaining the desired thermal performance, while preserving adequate transmission with satisfactory colorations, in particular in reflection.

The prior art relating to analogous systems has led to the choosing of systems whose reflecting layers are based on metallic silver. To obtain the lowest resistance it is necessary to employ layers exhibiting a certain thickness of silver, but the structure of the layer is also relevant. It is well known that IR filters deposited on glass sheets must be constructed as a well determined assembly of reflecting metallic layers and of dielectric layers which limit the reflections of the wavelengths in the visible. In order to be as selective as possible, and avoid unpleasant colorations in reflection whatever the angle of observation, these filters lead to the use not of one metallic layer but of several metallic layers separated by dielectric layers exhibiting both good transmission and well chosen refractive indices.

Having regard to the multiple demands, the best compromises are obtained with systems comprising three layers based on silver as infrared-reflecting layer. The total quantity of silver per unit surface area remains limited in particular so as not to excessively reduce the luminous transmission. But the allowable total quantity is dependent on the quality of the composition of the system as a whole. The total quantity of silver is not less than 300 mg/m² and advantageously is not less than 320 mg/m² and in a preferred manner is greater than 350 mg/m². For the most efficacious systems the total quantity of silver per unit surface area can attain 400 mg/m² or even 450 mg/m².

For one and the same total quantity of silver per unit surface area, the resistance is all the better when this quantity is distributed over a more limited number of layers. The interfaces between the conducting and dielectric layers not being perfect, proliferation thereof leads to an assembly whose resistance tends to increase. Choosing to produce the system with three silver layers makes it possible on the other hand, as indicated previously, to obtain good selectivity of the infrared filter and, therefore, to optimize the quantity of silver. The choice of three layers results from the best compromise, each of the layers offering a conductivity, which without being the best possible, attains values not very different from that of thicker layers.

In practice each of the silver layers comprises a minimum of 100 mg/m², and advantageously greater than 110 mg/m². Likewise each silver layer comprises at most 160 mg/m², and preferably at most 150 mg/m².

Transparent dielectric layers are well known in the applications considered. The appropriate substances are numerous and it is not useful to list them all here. They are in general oxides, oxy-nitrides or metal nitrides. Among the most commonplace may be cited by way of example SiO₂, TiO₂, SnO₂, ZnO, ZnAlOx, Si₃N₄, AlN, Al₂O₃, ZrO₂, Nb₂O₅, YOxTiZrYOx, TiNbOx, HfOx, MgOx, TaOx, CrOx and Bi₂O₃, and their mixtures. It is also possible to cite the following materials: AZO, ZTO, GZO, NiCrOx, TXO, ZSO, TZO, TNO, TZSO, TZAO and TZAYO. The expression “AZO” refers to a zinc oxide doped with aluminium or to a mixed oxide of zinc and of aluminium, obtained preferably on the basis of a ceramic cathode formed by the oxide to be deposited in a neutral or slightly oxidizing atmosphere. Likewise, the expressions ZTO or GZO refer respectively to mixed oxides of titanium and of zinc or of zinc and of gallium, obtained on the basis of ceramic cathodes in a neutral or slightly oxidizing atmosphere. The expression TXO refers to titanium oxide obtained on the basis of a ceramic cathode of titanium oxide. The expression ZSO refers to a zinc-tin mixed oxide obtained either on the basis of a metallic cathode of the alloy deposited under an oxidizing atmosphere or on the basis of a ceramic cathode of the corresponding oxide in a neutral or slightly oxidizing atmosphere. The expressions TZO, TNO, TZSO, TZAO or TZAYO refer respectively to mixed oxides of titanium-zirconium, titanium-niobium, titanium-zirconium-silicon, titanium-zirconium-aluminium or titanium-zirconium-aluminium-yttrium, obtained on the basis of ceramic cathodes, either in a neutral or slightly oxidizing atmosphere.

The materials to enter into the composition of the systems used according to the invention are chosen as a function of multiple criteria. They must be sufficiently transparent at the thicknesses that their refractive index controls.

Preferably, at least one of the dielectric layers is based on a zinc-tin mixed oxide containing at least 20%, and preferably at least 40% by weight of tin, for example about 50% to form Zn₂SnO₄. This oxide is very useful in the guise of dielectric coating in a stack able to undergo a thermal treatment.

Preferably, the lower dielectric coating arranged between the sheet of glassy substance and the first reflecting silver layer comprises at least one zinc-tin mixed oxide containing at least 20%, by weight of tin, and the external dielectric coating also comprises at least one zinc-tin mixed oxide containing at least 20% by weight of tin. This arrangement is very favourable for protecting the reflecting layers equally well in relation to oxidation originating from outside as to oxygen originating from the glassy substance in the treatments imposing a rise in the temperature, in particular during bending.

Preferably, the dielectric layer arranged under one or under each reflecting silver layer is a layer based on a zinc oxide, optionally doped for example with aluminium, with magnesium or with gallium. This layer is in direct contact with the silver layer or layers.

The layers based on zinc oxide can have a particularly favourable effect on the stability and the resistance to corrosion of the functional layer. They are also favourable to the improvement of conductivity.

Previously it has been proposed to construct the silver layers directly on a dielectric layer based on a zinc-tin mixed oxide not having more than about 20% by weight of tin and at least about 80% by weight of zinc, preferably not more than about 10% of tin and at least about 90% of zinc. This mixed oxide with a high zinc oxide content under, and in direct contact with, the layer based on silver, is advantageous for the conductivity of the silver layer which is superposed therewith. The association of this mixed oxide with high zinc content under the functional layer with a zinc-tin mixed oxide containing at least 20% by weight of tin in the lower and external dielectrics, constitutes the most advantageous structure for good resilience of the stack during a high-temperature thermal treatment.

Though the mixed zinc and tin oxides offer the stability required during the thermal treatments, it is apparent that it is more advantageous for the conductivity of the silver layers that they be formed on a zinc oxide layer with practically no other constituent than those present optionally in the state of impurities. The proportion by weight of these elements present in the zinc oxide remains in all cases less than 5% by weight and is advantageously less than 3%, and in a particularly preferred manner less than 1%.

Without being bound by this analysis, it seems that zinc oxide experiences different crystalline growths depending on whether a mixed oxide or an almost pure oxide is being employed. Mixed oxides would be less sensitive to changes at high temperature, the structure being less crystalline, or if desired more amorphous. This is what seems to be shown by X-ray diffraction crystallographic analyses. The traditional peaks of the zinc crystals are less intense therein. Conversely the presence of a layer of zinc oxide whose crystallinity is not modified by foreign bodies is apparently a factor which promotes a crystallization of the silver layers that is favourable to their conductivity. X-ray diffraction crystallographic study of the silver layers of the two sorts clearly shows differences of structure.

According to the invention it is simultaneously possible to benefit from the effect of promotion of the layer of silver related to the presence of the layer of practically pure zinc oxide, and from the thermal stability of this layer provided that the layer in question is not too thick. In practice it is advantageous that the zinc oxide layer on which the silver layer is deposited not be greater than 110 Å and preferably not greater than 90 Å in thickness. This layer for improving the properties of the silver layer must nonetheless exhibit a certain thickness which makes it possible to achieve the crystallinity sought. In practice the layer of practically pure zinc oxide exhibits a thickness of at least 40 Å, and preferably of at least 50 Å.

In addition to the dielectrics previously in question it is also traditional, in particular for systems having to undergo thermal treatments of the tempering bending type, to employ so-called “barrier” or “sacrificial” layers above the layers based on silver. These layers are thin metallic layers, optionally partially oxidized, whose role is to preclude the oxidation of the underlying layer by becoming oxidized themselves. These layers must be sufficiently thin and of a material that is as transparent as possible so as not to appreciably diminish the luminous transmission of the assembly. To achieve the best possible transmission these layers are preferably completely oxidized in the thermal treatment operations.

The metals most customarily used to construct these barrier layers, are in particular Ti, Zn, Al, Nb and NiCr alloys.

The thicknesses of the barrier layers are not ordinarily greater than 8 nm, and usually, are less than or equal to 6 nm. For the NiCr alloys that are particularly resistant to oxidation the thickness is preferably less than 4 nm.

The invention is described in detail hereinafter by referring to the plates of drawings in which:

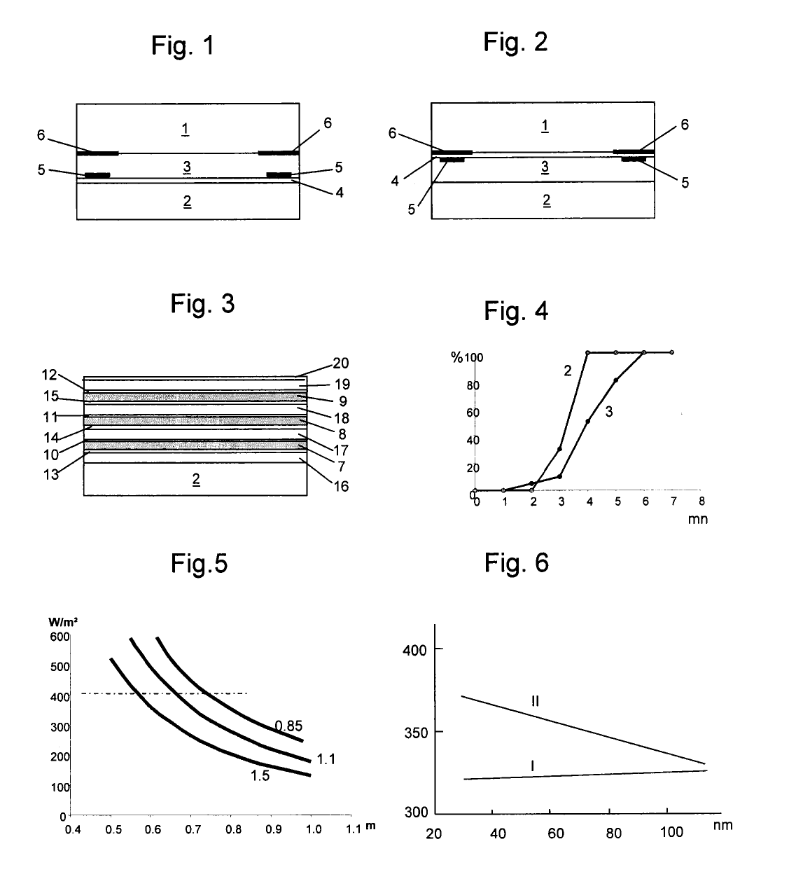

FIG. 1 is a schematic representation of a cross-section of a glazing according to the invention;

FIG. 2 is a representation of a glazing according to the invention presenting another structure;

FIG. 3 presents in cross section a system of layers entering into the composition of a glazing according to the invention;

FIG. 4 is a graph displaying the evolution of a deicing operation as a function of time, for a glazing according to the invention, according to the position of the heating system;

FIG. 5 is a graph illustrating the power developed as a function of the sheet resistance of the system of layers, and of the distance between the busbars;

FIG. 6 is a graph showing the influence of the thickness of the ZnO layer on the quality of the silver layers;

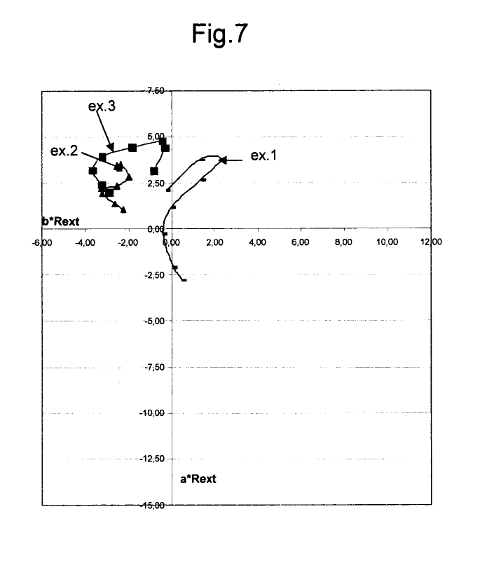

FIG. 7 illustrates the stability of the neutrality in reflection of coated glass sheets, by varying the angle of observation with respect to the normal.

In FIGS. 1 and 2 two types of laminated glazing structures are presented. The dimensions do not reflect those of the products, neither in absolute value nor in their respective ratios.

The glazings both comprise an assembly of two glass sheets 1, 2, joined together by a thermoplastic insert sheet 3. In the representation the glass sheets are of different thickness. Though this structure is advantageous, it is not exclusive of structures in which the sheets exhibit identical thicknesses. The choice of different thicknesses addresses questions of optimization of the total thickness, by taking account of the distinct respective roles of each of these sheets.

As indicated previously the sheet directed towards the outside is potentially the one most exposed to mechanical hazards, in particular to the risks of breakage by projection of gravel. So as not to lose mechanical quality, the glazings according to the invention thus preferably comprise the thickest sheet directed towards the outside of the vehicle. In FIGS. 1 and 2, the thickest sheet is the sheet 1.

In these two figures a system of heating layers that filters infrared is represented globally at 4. In FIG. 1, the system of layers is in position 3, between the sheet 2 and the interlayer 3.

To power the heating system, two busbars are shown diagrammatically at 5. The busbars are situated on either side of the glazing. Their position and their dimensions are chosen so as to establish a current in the system of layers, over the whole of the surface of the glazing extending between these busbars. As indicated previously the busbars are arranged in the least large dimension of the glazing so as to maintain the highest possible power having regard to the available voltage applied, and to the resistance of the system of layers.

The busbars 5 are chosen so as to offer the lowest possible electrical resistance in order to employ the highest voltage for the power supply of the system of layers 4.

Traditionally glazings such as windscreens are glued onto the bodyshell on their face directed towards the cabin, that is to say in position 4. To mask the presence of the gluing marks upon observation from outside, strips of dark enamel 6 are arranged facing the locations of the glue lines. The busbars 5 being situated at the periphery of the glazing so as not to blot out the zone of vision of the glazing, they are situated as represented in the zones covered also by the enamelled strips 6, and are simultaneously masked by these enamelled strips 6.

In FIG. 1 the enamelled strips 6 are arranged in position 2 on the sheet 1. The system of layers 4 is applied in position 3 on the sheet 2. The separation of the enamels and functional layers facilitates the shaping, optionally simultaneous, of the two sheets in the bending or tempering treatment. Even if the positions 2 and 3 of the sheets are situated face to face during this treatment, it is possible without overly constraining precautions to avoid impairments caused by the contact of the enamel 6 and of the system of layers 4, and/or that of the busbars. Accordingly diverse measures are possible.

On the one hand the enamelled zones can be “prebaked” to eliminate therefrom all the solvents initially contained in the pastes applied. This prebaking also solidifies the enamelled strips which are no longer “sticky” upon superposition of the glass sheets during the thermal bending treatment. Moreover to avoid contact of the enamelled strips 6 with the system of layers it is usual to interpose an antiadhesive powder which is eliminated after the thermal shaping of the glass sheets.

FIG. 2 presents another structure. In the latter the enamelled strips 6 and the system of heating layers 4 with the busbars 5, are all on the face 2 of the external sheet 1. In this arrangement, the system of layers 4 is applied to the sheet 1 after the enamelled strips 6 have been prebaked. The busbars as previously are applied to the previously constructed system of layers.

In both cases the sheets 1 and 2 are thereafter assembled in a traditional manner with an insert sheet 3 in an oven pass.

FIG. 3 is an exemplary system of heating layers usable according to the invention. The system is presented applied to a glass sheet such as for example in the structure of FIG. 1.

On the glass sheet 2 the system illustrated comprises three infrared-reflecting conducting layers 7, 8, 9. These usually entail metallic layers based on silver. Advantageously, the silver is pure, but it can be doped with a few per cent of palladium, of aluminium or of copper, at a rate of for example from 0.1 to 10 atom % preferably from 0.3 to 3.0%.

The silver layers are three in number so as to achieve as low as possible a sheet resistance without compromising the optical properties, in particular the reflection and the neutrality of the colour in reflection whatever the angle of observation.

Dielectric layers complete the system between the glass substrate 2 and the first silver layer 7, between the silver layers 7 and 8 on the one hand and 8 and 9 on the other hand, finally above the silver layer 9.

Advantageously the silver layers are covered with a barrier layer (10, 11, 12) composed of an optionally partially oxidized metal. The barrier layers are very slender and protect the silver against oxidation by becoming oxidized themselves in the successive reactive depositions of the superposed dielectric layers, and in the thermal shaping treatments.

The barrier layers are advantageously of titanium, because of the good transparency of the titanium oxide layers, but other metals are also possible that are traditionally used for these layers.

In the intermediate dielectric layers, those on which the silver layers rest contribute in an appreciable manner to the quality and to the structure of the silver layers. These layers (13, 14, 15) are based on zinc oxide. The layers in question can if appropriate consist of a mixed zinc and tin oxide with a limited proportion of tin so as to stabilize the structure of the layer, and avoid its modification in particular during thermal treatments. But according to the invention it is preferred to use layers of practically pure zinc oxide, that is to say an oxide whose foreign components are not greater than 5%, preferably not greater than 3% and more particularly not greater than 1% by weight. The presence of these zinc oxide layers, when they are of well delimited thicknesses, leads to silver layers offering the best conductivity.

Apart from the previously named layers the systems further comprise at least one dielectric layer completing the “dereflecting” system between the glass sheet (16) and the first silver layer, between the silver layers (17, 18), and above the third silver layer (19). The preferred additional layer is a layer based on mixed zinc and tin oxide whose proportions are advantageously of the order of 50% by weight of each of the constituent oxides.

The system furthermore often comprises a protective superficial layer (20) advantageously also of an oxide of good mechanical strength such as titanium oxide. This superficial layer is relatively thin so as to limit its influence in the interferential system.

The infrared-reflecting layers, and also the dielectric layers which are associated therewith, must satisfy ratios defined so as to constitute the most efficacious interferential systems. The ratios in question are detailed in particular in patent application BE2010/0311, filed on 25 May 2010 by the applicant, which application is incorporated by reference, in particular in respect of the most advantageous conditions as regards the ratios of the thicknesses of the various layers.

A first particularly preferred exemplary reflecting system is constructed in the following manner in which the thicknesses are expressed in angstroms:
glass/Zn₂SnO₄/ZnO/Ag/Ti/Zn₂SnO₄/ZnO/Ag/Ti/Zn₂SnO₄/ZnO/Ag/Ti/Zn₂SnO₄/TiO₂
th.Å 310 70 141 20 660 80 144 30 630 80 131 20 293 54 ex.1

The system is applied to an ordinary “float” glass sheet 1.25 mm in thickness. The sheet is subjected to a thermal treatment at 650° C. for 8 min. The optical properties are measured glass side (face 1 of the glazing) before assemblage into the laminated glazing.

The illuminant is D65, at 10° for normal incidence. The luminous transmission (measured like the other optical parameters according to standard EN410) TL is 78.6%, the reflection RL is 6.3%, the colorimetric data (expressed in the CIELAB 1976 system) are L*91.1, a*0.0, b*2.6.

The resistance measurements performed on the glazing lead to a value of 0.85Ω/□. For a voltage of 14 v and a distance between busbars of 0.75 m corresponding to a windscreen of good dimensions, the available power is then about 410 w/m².

On the same system of layers as in the previous example two other examples are produced by varying the respective thicknesses of certain layers in a limited manner. Two examples 2 and 3 are proposed.
glass/Zn₂SnO₄/ZnO/Ag/Ti/Zn₂SnO₄/ZnO/Ag/Ti/Zn₂SnO₄/ZnO/Ag/Ti/Zn₂SnO₄/TiO₂
th.Å 310 70 140 20 660 80 140 30 630 80 120 20 290 60 ex.2
310 70 130 20 660 80 130 30 630 80 110 20 290 60 ex.3

The resistances of these stacks of layers are established respectively at 0.85Ω/□ and 0.9Ω/□.

For all these three examples once the coated sheets have been assembled with an ordinary “float” glass sheet which is 1.9 mm in thickness, and a 0.76 mm colourless PVB interlayer, the values of the optical properties, transmission (TL), energy transmission (TE), luminous reflection towards the outside (RL), luminous reflection towards the inside (Rint), energy reflection towards the outside (REext) and towards the inside (REint) are established as follows:

| | TL | RL | Rint | TE | REext | REint73.2 |
|---|---|---|---|---|---|---|
| Ex. 1 | 73.2 | 10 | 11 | 32.5 | 40.4 | 47.4 |
| Ex. 2 | 71.9 | 10 | 10.7 | 33.9 | 37.9 | 44.3 |
| Ex. 3 | 71.3 | 10.5 | 11 | 32 | 40.1 | 46.6 |

These three glazings exhibit satisfactory characteristics for a windscreen both from the point of view of luminous transmission and energy characteristics.

For the above three examples the colour variation in reflection has been established according to the angle of observation. This property is sensitive for automobile glazings in particular for windscreens. The latter are indeed at one and the same time very inclined and bent. It is highly desirable that the appearance of these glazings be as neutral as possible whatever the position of the observer and that furthermore this appearance be very uniform for the entirety of the glazing although the latter is viewed at various angles simultaneously, depending on the part observed.

The three examples above show high stability of reflection at these various angles as indicated by the following table whose elements are reproduced on the graph of FIG. 7.

The colorimetric coordinates L*, a* and b* as well as the variation ΔC* (which is the square root of the squares of the variations of a* and b*) are expressed as a function of the angle of observation. The angle is indicated with respect to the normal to the glazing.

| | | 8.5° | 15° | 25° | 35° | 45° | 55° | 65° |
|---|---|---|---|---|---|---|---|---|
| Ex. 1 | L* | 38.2 | 38.3 | 37.7 | 38.6 | 40.2 | 44.4 | 52.6 |
| | a* | 0.5 | 0.1 | −0.4 | 0.0 | 1.4 | 2.3 | 1.3 |
| | b* | −2.8 | −2.1 | −0.2 | 1.2 | 2.7 | 3.8 | 3.8 |
| | C* | 0.8 | 1.9 | 1.5 | 2.0 | 1.4 | 1.0 | |
| Ex. 2 | L* | 39.1 | 39.0 | 38.8 | 39.3 | 41.1 | 45.7 | 55.0 |
| | a* | −2.2 | −2.6 | −3.2 | −3.3 | −2.6 | −2.0 | −2.4 |
| | b* | 1.1 | 1.4 | 1.9 | 2.2 | 2.3 | 2.8 | 3.5 |
| | C* | 0.5 | 0.8 | 0.3 | 0.7 | 0.7 | 0.8 | |
| Ex. 3 | L* | 37.6 | 37.5 | 37.6 | 38.0 | 39.9 | 44.2 | 53.0 |
| | a* | −2.9 | −3.3 | −3.7 | −3.2 | −1.8 | −0.4 | −0.3 |
| | b* | 2.0 | 2.4 | 3.2 | 3.9 | 4.4 | 4.8 | 4.4 |
| | C* | 0.5 | 0.9 | 0.9 | 1.5 | 1.4 | 0.4 | |

The three examples show not only very good neutrality in reflection, but also little variation depending on the angle of observation.

Another system of layers according to the invention is the following, the thicknesses as previously being expressed in angstroms:
glass/AlN/AZO/Ag/ZnAl/AZO/Ag/ZnAl/AZO/Ag/ZnAl/AZO/AlN
th.Å 160 220 140 20 790 140 20 750 130 20 260 100

In this stack: AZO designates the ZnAlOx layer with 5 atom % of aluminium with respect to the ZnAl assembly; the ZnAl barriers are an alloy with 12 atom % of Al.

“Deicing” trials are carried out on samples prepared with the first system of layers. The samples consist of 30×30 cm squares. In this trial the glass sheets are respectively 2.1 and 1.6 mm in thickness, the PVB interlayer 0.76 mm. The system of layers is applied in position 2 or in position 3.

The formation of the ice layer is conducted in a refrigerated chamber at −18° C. The quantity of water applied to the surface of the sample is 0.5 kg/m².

The percentage of deiced surface, the sample being maintained in the refrigerated chamber, is measured as a function of time of application of the power adjusted to 410 w/m² by adapting the voltage to the dimensions of the sample.

The results are represented in FIG. 4. The curves correspond to positions 2 and 3 of the heating system of layers. It is noted that the deicing takes place more quickly in the case of the heating system of layers arranged in position 2. The gain is of the order of a minute in the obtaining of complete deicing. This difference is very obviously to do with the mode of conduction of the heat in the glazing. The proximity of the heat source favours the heating of the face to be deiced.

Conversely the heating system of layers in position 3 would favour the fast demisting of the face directed towards the cabin.

FIG. 5 illustrates in a schematic manner the impact of the available power as a function of the resistance of the system of layers for three values of the latter, and of the distance separating the busbars on the glazing. Though with a resistance of 0.85/Ω□, as in the previous case, the distance can be greater than 75 cm to have a power of the order of 400 w/m², it is seen that this distance decreases very quickly as the resistance rises. Thus for a resistance of 1.5Ω/□ this distance, stated otherwise, the actually deiced height of the windscreen, is now only about 60 cm.

FIG. 6 shows the influence of the thickness of the zinc oxide layer on the performance of the silver layers in the system described hereinabove by simultaneously varying the three zinc oxide layers present.

The graph represents the variation in the quality of the silver, which is defined as the product of the sheet resistance expressed in ohms, times the quantity of silver per unit surface area expressed in milligrams per square metre.

1. A laminated automobile glazing, comprising:
a first glass sheet and a second glass sheet assembled via a thermoplastic insert sheet, and
a system of electrically conducting functional thin layers applied to a face of the first glass sheet, and arranged between the first glass sheet and the insert sheet,
wherein
the glazing has a luminous transmission of not less than 70%,
the system of electrically conducting layers is powered via conducting strips arranged on the electrically conducting layers and on either side of the glazing, and
a total thickness of the glass sheets of the glazing is at most equal to 3.8 mm.

2. The glazing according to claim 1, wherein the total thickness of the glass sheets is at most equal to 3.5 mm.

3. The glazing according to claim 1, wherein the total thickness of the glass sheets is at most equal to 3.2 mm.

4. The glazing according to claim 1, comprising at least one glass sheet with a thickness of not greater than 1.6 mm.

5. The glazing according to claim 1, wherein
the glass sheets are of different thicknesses, and
a sheet that is the thickest directs towards an outside of a vehicle.

6. The glazing according to claim 1, wherein a heating system of layers comprises:
an assembly of three conducting layers based on silver, and
dielectric layers protecting the three conducting layers and adjusting optical properties of the assembly.

7. The glazing according to claim 6, wherein the three conducting layers based on silver comprise a total quantity of silver of not less than 300 mg/m².

8. The glazing according to claim 7, wherein the total quantity of silver is not less than 350 mg/m².

9. The glazing according to claim 6, wherein each of the three conducting layers based on silver comprises at least 100 mg/m² of silver.

10. The glazing according to claim 6, wherein each of the three conducting layers based on silver comprises at most 160 mg/m² of silver.

11. The glazing according to claim 6, wherein the three conducting layers based on silver rest on a layer based on zinc oxide comprising zinc oxide of at least 80% by weight.

12. The glazing according to claim 11, wherein the layer based on a zinc oxide comprises foreign components of less than 5% by weight.

13. The glazing according to claim 12, wherein the layer based on zinc oxide has a thickness of not greater than 110 Å.

14. The glazing according to claim 12, wherein the layer based on zinc oxide has a thickness of at least 40 Å.

15. The glazing according to claim 11, wherein
the layer based on zinc oxide rests on layers of mixed zinc and tin oxide, and
a percentage by weight of tin in the layers of mixed zinc and tin oxide is at least 20%.
